(19) United States
(12) Patent Application Publication
(10) Pub. No.: US 2025/0350153 A1
(43) Pub. Date: Nov. 13, 2025

(54) INTEGRATION OF COIL AND CAPACITOR FOR A WIRELESS POWER SYSTEM

(71) Applicant: UT-Battelle, LLC, Oak Ridge, TN (US)

(72) Inventors: Vandana Rallabandi, Knoxville, TN (US); Lingxiao Xue, Oak Ridge, TN (US); Gui-Jia Su, Knoxville, TN (US); Mostak Mohammad, Knoxville, TN (US); Veda Prakash Galigekere Nagabhushana, Knoxville, TN (US)

(21) Appl. No.: 19/199,647

(22) Filed: May 6, 2025

Related U.S. Application Data
(60) Provisional application No. 63/643,455, filed on May 7, 2024.

(51) Int. Cl. H02J 50/12; B60L 53/122; H01F 27/29

(52) U.S. Cl. CPC H02J 50/12; B60L 53/122; H01F 27/29

(57) ABSTRACT

A component for wireless power transfer is provided with tuning capacitors integrated with coils. For instance, a single turn coil can be split into two halves and capacitance (other than self-capacitance) may be implemented by introducing a dielectric layer between portions of the two half turns.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present disclosure relates to the field of wireless power transmitters and receivers for a wireless power system, and more particularly toward integration of an inductor and a capacitor for a wireless power transmitter and/or a wireless power receiver.

### BACKGROUND

Wireless power systems (WPS), including wireless charging systems (WCS), have shown a significant promise of flexibility and reliability for electric vehicle charging. It has been demonstrated with high power and efficiency for electric drones, cars, buses, trucks, ships, etc., with high power and efficiency. Drones, in general unmanned aerial vehicles (UAVs), are one of the most promising applications for wireless charging technologies. The UAV application often involves unattended, hands-free, automated, all-environment, and highly reliable charging infrastructure, which makes the WCS a highly fitting charging solution.

The design methodology of a high-frequency, high-power, long-distance inductive WPS for wireless power transfer (WPT) utilizes an airgap (d) between a transmitter (wireless power transmitter) and a receiver (wireless power receiver). In a conventional high-power (>1 kW) WPT, d is limited to a few hundred millimeters, which is almost ¼th of the coil diameter, D—i.e., d≤D/4.

While d≈D/4 has unlocked a large number of applications, such as cell phones and industrial robots for electric vehicles, conventional efforts for long-distance (d>D) WPT are less capable and lacking in ability to transfer power effectively.

### SUMMARY

In general, one innovative aspect of the subject matter described herein can be embodied in a wireless charging system (WCS) for wirelessly providing high-frequency AC power to an electric vehicle (EV). The WCS may include an off-board transmitter (TX) including a primary coil configured to wirelessly transmit the high-frequency AC power. The primary coil may include a Cu-foil winding and a primary-side resonant-tuning network (RTN) that is integrally formed with the primary coil. The primary-side RTN may include a first capacitor that includes first Cu plates located at the ends of the primary coil's Cu-foil winding and a dielectric sandwiched between the first Cu plates.

The WCS may include an on-board receiver (RX) including a secondary coil configured to receive the high-frequency AC power when the secondary coil and the primary coil are disposed adjacent to each other and spaced apart through a gap d. The secondary coil may include a Cu foil winding and a secondary-side RTN that is integrally formed with the secondary coil. The secondary-side RTN may include a second capacitor that includes second Cu plates located at the ends of the secondary coil's Cu-foil winding and another dielectric sandwiched between the second Cu plates.

The foregoing and other embodiments can each optionally include one or more of the following features, alone or in combination. In particular, one embodiment includes all the following features in combination.

In some embodiments, the first capacitor's first plates may be portions of the primary coil's Cu-foil winding. The portions may have a predetermined length measured from respective ends of the primary coil's Cu-foil winding. The second capacitor's second plates may be portions of the secondary coil's Cu-foil winding. The portions may have the predetermined length measured from respective ends of the secondary coil's Cu-foil winding.

In some embodiments, the first capacitor's first plates may be fastened at, and extend from, respective ends of the primary coil's Cu-foil winding. The second capacitor's second plates may be fastened at, and extend from, respective ends of the secondary coil's Cu-foil winding.

In some embodiments, the primary coil may include multiple Cu-foil windings. The secondary coil may include multiple Cu-foil windings.

In some embodiments, the secondary-side RTN may include copies of the second capacitor in one-to-one correspondence with the secondary coil's Cu-foil windings.

In some embodiments, the primary-side RTN may include at least one copy of the first capacitor, and the secondary-side RTN may include at least one copy of the second capacitor.

In some embodiments, the primary-side RTN may include copies of the first capacitor in one-to-one correspondence with the primary coil's Cu-foil windings. The secondary-side RTN may include copies of the second capacitor in one-to-one correspondence with the secondary coil's Cu-foil windings.

In some embodiments, the off-board TX may include an inverter. The primary coil's Cu-foil winding may include first electrical terminals for connecting the primary-side RTN to the inverter. The first electrical terminals may be disposed distal from its ends where the first capacitor is disposed. The on-board RX may include a rectifier, and the secondary coil's Cu-foil winding may include second electrical terminals for connecting the secondary-side RTN to the rectifier. The second electrical terminals may be disposed distal from its ends where the second capacitor is disposed.

In some embodiments, the off-board TX may include an inverter. The primary coil's Cu-foil winding may include first electrical terminals for coupling the primary-side RTN to the inverter. The first electrical terminals may be disposed across its ends where the first capacitor is disposed. The on-board RX may include a rectifier, and the secondary coil's Cu-foil winding may include second electrical terminals for coupling the secondary-side RTN to the rectifier. The second electrical terminals may be disposed across its ends where the second capacitor is disposed.

In some embodiments, the primary-side RTN may include two first inductors connected between the respective first electrical terminals and the inverter, and the secondary-side RTN may include two second inductors connected between the respective second electrical terminals and the rectifier.

In some embodiments, the primary-side RTN may include a third capacitor that includes third Cu plates located distal from the ends of the primary coil's Cu-foil winding where the first capacitor is disposed. The dielectric may be sandwiched between the third Cu plates, and the secondary-side RTN may include a fourth capacitor that includes fourth Cu plates located distal from the ends of the secondary coil's Cu-foil winding where the second capacitor is disposed. The dielectric may be sandwiched between the fourth Cu plates.

In some embodiments, the high-frequency AC power may be in a range of 1-10 kW.

In some embodiments, a fundamental frequency of the high-frequency AC power may be in a range of 1 MHz-10 MHz.

In some embodiments, a ratio of the gap d to a diameter D of the Cu-foil winding(s) may satisfy the conditions 1<d/D<2.

In some embodiments, the gap d may be in a range of 1 m to 10 m.

In some embodiments, the EV may be one of an automobile, a watercraft, or an aircraft.

In some embodiments, the EV may be an autonomous vehicle.

In some embodiments, the off-board TX may be disposed on the ground, a wall, or a ceiling.

In some embodiments, the off-board TX may be disposed on an automobile, a watercraft, or an aircraft.

In general, one innovative aspect of the subject matter described herein can be embodied in a resonant component for transfer of wireless power between a wireless power supply and a remote device. The resonant component may include a first inductive portion including a first end and a second inductive portion including a second end. The resonant component may include a first electrode operable to store electric charge, where the first electrode may provide at the first end of the first inductive portion. The resonant component may include a second electrode operable to store electric charge, where the second electrode may be provided at the second end of the second inductive portion. The resonant component may include a dielectric sandwiched between the first electrode and the second electrode, where the first electrode, the second electrode, and the dielectric form a capacitor integral to an inductor defined at least by the first and second inductive portions.

The foregoing and other embodiments can each optionally include one or more of the following features, alone or in combination. In particular, one embodiment includes all the following features in combination.

In some embodiments, the resonant component may correspond to at least one of a wireless transmitter and a wireless receiver respectively for the wireless power supply and the remote device.

In some embodiments, the first and second inductive portions may include first and second Cu-foil portions, and where the first electrode may be disposed directly on the first end of the first Cu-foil portion.

In some embodiments, the second electrode may be disposed directly on the second end of the second Cu-foil portion.

In some embodiments, the dielectric may be sandwiched between the first and second ends of the first and second Cu-foil portions, such that the dielectric is disposed in a layered arrangement that includes the first end, the first electrode, the dielectric, the second electrode, and the second end.

In some embodiments, the first electrode may be fastened at, and extends from, the first end of the first inductive portion.

In some embodiments, the second electrode may be fastened at, and extends from, the second end of the second inductive portion.

In some embodiments, the first electrode may correspond to a first capacitor plate of the capacitor, and the second electrode may correspond to a second capacitor plate of the capacitor.

In some embodiments, the first inductive portion may correspond to a first half turn, where the second inductive portion may correspond to a second half turn, and where the first and second half turns may define a first turn of the inductor for transfer of wireless power.

In some embodiments, the capacitor and the inductor may be operable to resonate.

In some embodiments, the inductor may include at least one additional turn, where each of the at least one additional turns may include a first additional inductive portion including a first additional end and a second additional inductive portion including a second additional end. The first additional electrode may be operable to store electric charge, where the first additional electrode may be electrically coupled to the first additional end of the first additional inductive portion. A second additional electrode may be operable to store electric charge, where the second additional electrode may be electrically coupled to the second additional end of the second additional inductive portion. An additional dielectric may be sandwiched between the first and second additional electrodes, where the first additional electrode, the second additional electrode, and the additional dielectric form an additional capacitor integral to an additional inductor defined by the first and second additional inductive portions.

In some embodiments, a wireless power supply for supply of power wirelessly a remote device may be provided. The wireless power supply may include a wireless power transmitter according to a resonant component according to one or more embodiments described herein. The wireless power supply may include a power source interface operable to receive power from a power source, and a converter electrically coupled to an output of the power source interface. The converter may be configured to convert power from the output of the power source interface for supply to the wireless power transmitter to transmit power wirelessly to the remote device.

In some embodiments, a remote device for receipt of power wirelessly transmitted by a wireless power supply may be provided. The remote device may include a wireless power receiver according to a resonant component according to one or more embodiments described herein. The remote device may include a rectifier operably coupled to the wireless power receiver. The rectifier may be operable to convert AC power output from the wireless power receiver into DC power as an output. The remote device may include a load operably coupled to the output of the rectifier, the load operable to draw DC power from the rectifier.

In some embodiments, the inductor and capacitor may be arranged in a series turning configuration, a parallel tuning configuration, or a series-parallel tuning configuration.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows a perspective view of a resonant component according to one embodiment.

FIG. 2 shows a top view of the resonant component in FIG. 1.

FIG. 3 shows an enlarged view of the resonant component in FIG. 1.

FIG. 4 shows a representative view of the resonant component in FIG. 1.

FIG. 5A shows a perspective view of a resonant component according to one embodiment.

FIG. 5B shows an exploded, enlarged view of the resonant component in FIG. 5A.

FIG. 6 shows a sectional view of the resonant component in FIG. 5A.

FIG. 7 shows a resonant component according to one embodiment.

FIG. 8 shows a resonant component of FIG. 7.

FIG. 9 shows a representative view of the resonant component of FIG. 7.

FIG. 10 shows a resonant component according to one embodiment.

FIG. 11 shows a resonant component according to one embodiment.

FIG. 12 shows a resonant component in a multi-turn configuration according to one embodiment.

FIG. 13 shows a wireless power system according to one embodiment.

FIG. 14 shows an analysis and comparison of distance between resonant components for a wireless power system according to one embodiment.

### DESCRIPTION

Wireless power systems often include a transmitter coil, receiver coil, tuning capacitors, and power electronics converters. These systems may be operated at high frequency at or near resonance to increase or maximize power transfer distance and efficiency. Often times, high voltages appear across the inductors and capacitors. A resonant component of the wireless power system in accordance with one embodiment can be used in fields such as transportation or energy and utilities. More specifically, a resonant component according to one embodiment may be used to produce self-resonant coils and/or resonant networks for use in wireless power systems, including wireless charging applications.

Use of discrete components may reduce efficiency and increase system complexity. According to one embodiment, integration of the tuning capacitors with the transmitter and receiver coils may be provided, forming a resonant component (e.g., an integrated resonant component). This may lead to enhanced control over the parasitics and improvements in efficiency, power density, and system footprint.

A system according to one embodiment is described with the tuning capacitors integrated with the coils. For instance, a single turn coil can be split into two halves and capacitance (other than self-capacitance) may be implemented by introducing a dielectric layer between the two half turns. A number of tuning embodiments may be implemented by different types of connections, e.g., to yield series tuning, parallel tuning, LCC tuning, and LCL tuning.

The system, in one embodiment, may be configured for transfer of AC power in a range of 1-10 kW. The frequency of power transfer, e.g., fundamental frequency of the AC power, may be in the range of 1-10 MHz.

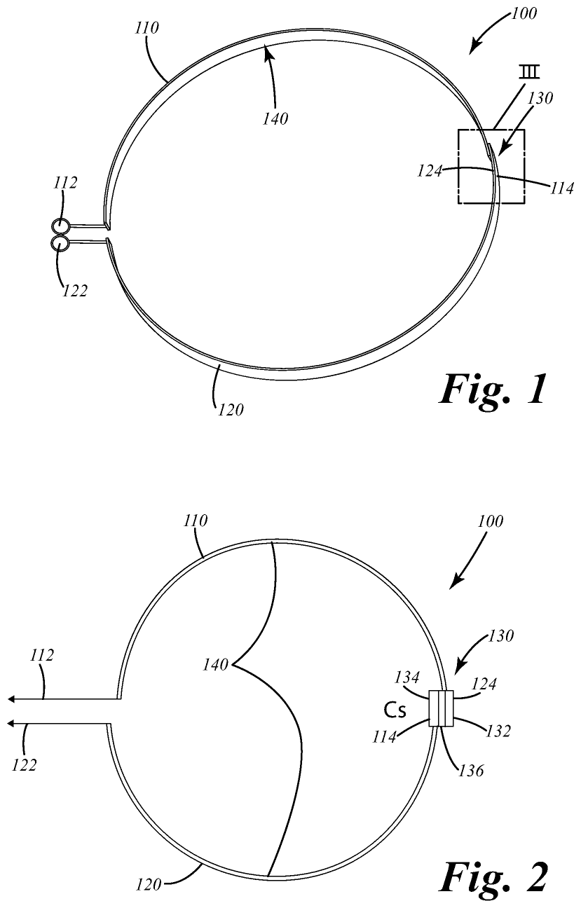

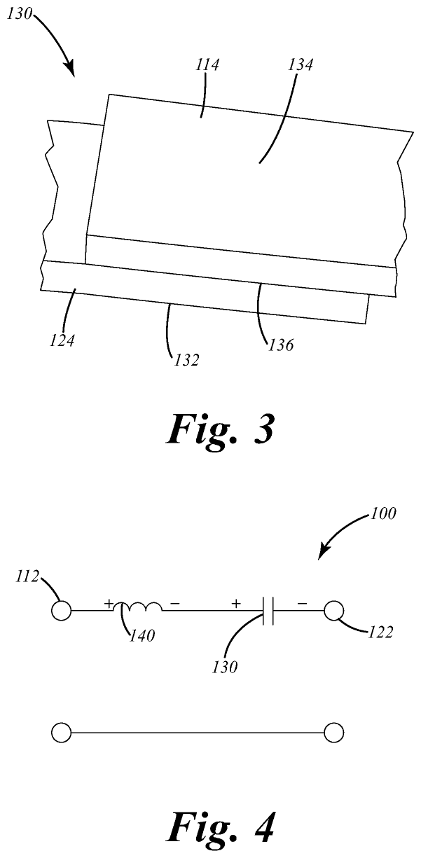

A resonant component for transfer of wireless power between a wireless power supply and a remote device is shown in FIGS. 1-4 according to one embodiment and is generally designated 100. The resonant component 100 may be configured as a wireless power receiver or a wireless power transmitter respectively provided in a remote device or a wireless power supply. The resonant component 100 may include an inductor 140 and a capacitor 130 that is integral to the inductor 140. The inductor 140 and the capacitor 130 may be operable to resonate in response to supply of AC power.

The inductor 140 may correspond to a primary coil or secondary coil construction operable to wirelessly transmit or receive high-frequency AC power. The inductor 140, as described herein, may include a copper foil winding—although different constructions may be utilized depending on the application.

The inductor 140 and the capacitor 130 may provide a resonant tuning network that is integrally formed with the resonant component 100. For instance, the capacitor 130, as described herein, may include electrodes (e.g., first and second copper plates) located at the ends of the inductor 140 (e.g., at the ends of the primary coil's copper foil winding), and a dielectric sandwiched between the electrodes. The electrodes may form portions of the inductor 140 (e.g., portions of the copper foil winding).

The resonant component 100 according to one embodiment may be used in a 6.78 MHz high power inductive wireless charging system. The coil or inductor 140 may be constructed of copper foil (or another type of suitable material) and a series tuning capacitor may integrated within the coil path. In general, the copper foil has better performance over Litz wire and copper tube around 6.78 MHz frequencies.

In one embodiment, the resonant component 100 may be used for both a transmitter and receiver of a WPS with copper foil-based coupler constructions, and a GaN-based inverter and rectifier. Experimental results indicate about 62.1% efficiency at 300 W power transfer over 1 m airgap—although results may vary depending on the application and configuration.

A sensitivity analysis of the self-resonant coils, as a function of coil shape and misalignment, can be considered in constructing the resonant component 100.

The WPS according to one embodiment, may be configured to track (dynamically during operation based on sensor feedback or statically based component selection) the resonant frequency of the tuning capacitors integrated with the coils, and so the system can be operated at an enhanced or optimal frequency relative to the resonant frequency. Furthermore, in one embodiment, a higher order integrated resonant tank (e.g., LCC, LCL, etc.) can be used to increase the system's robustness against frequency and load variation.

A resonant component 100 according to one embodiment can be applied to single turn copper foil conductors, and the resonant component 100 may be adapted for several different types of tuning techniques (series, series parallel, LCC, LCL, etc.). Additional turns may be provided for the resonant component 100, such as with a copper foil portion that includes more than a half turn (e.g., one or more turns and/or one or more partial turns). Self-resonant coils can be applied for multi-turn coil configurations with multiple resonant component configurations according to one or more embodiments described herein. For instance, in one multi-turn configuration, series tuning with multiple self-resonant components 100 can be achieved.

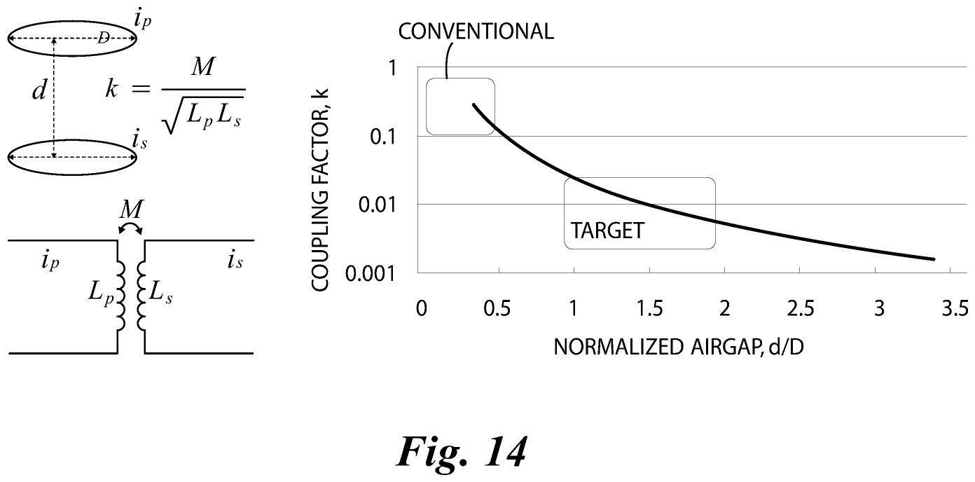

FIG. 14 shows the variation of the coupling coefficient with the normalized airgap (d/D), where d is the airgap distance and D is the diameter of the equally sized transmitter and receiver. FIG. 14 indicates that long-distance provides a low coupling coefficient. At this low coupling coefficient, the amount of flux that needs to be generated by a transmitter to induce a target voltage at a receiver becomes high, as only a small fraction (k) of that flux is coupled to the receiver. As a result, the power transfer capability becomes inherently low. The resonant component construction according to one embodiment may mitigate these effects.

In one embodiment, a ratio of the gap d to a diameter D of a first resonant component 100 in a wireless power supply 1110 and a second resonant component 100 in a remote device 1102 (e.g., between Cu-foil winding(s)) may satisfy the conditions 1<d/D<2. The gap d between the first and second resonant components 100 may be between 1 m and 10 m. It is noted that this ratio and the gap d may be implemented with respect to a wireless power supply 1110 and a remote device 1102 that respectively include resonant components according to one or more embodiments described herein, including, for instance, a resonant component 100, 100′, 200, 300, 400, 500, where the wireless power supply 1110 may include a resonant component 100, 100′, 200, 300, 400, 500 different from a resonant component 100 100′, 200, 300, 400, 500 of the remote device 1102.

Although equally sized transmitter and receiver constructions are described, it is to be understood that the diameter D of a transmitter may be different from the diameter D of a receiver depending on the application.

In one embodiment, the power transfer distance for a WPS using the resonant component 100 may be significantly increased (d≥1.5 D) by adopting a high-frequency magnetic configuration and GaN-based power electronics. For instance, a high frequency 6.78 MHz wireless charging system according to one embodiment may be configured to transfer 1 kW power over a 3 m airgap. Such a long-D WPT may use a transmitter and receiver (e.g., transmitter and receiver pads) a few times smaller and lighter for a high-power application, and enable use in applications such as hovering Drone, on-flight plane-to-plane, UAV-to-UAV, on-road EV-to-EV WPT, and many more. To achieve such targets, high frequency operation may be used.

The fundamental power transfer capability for a coupled inductor can be expressed as:

$$P = ω {MI}_{p} {I}_{s} = 2 π f k \sqrt{{L}_{p} {L}_{s}} {I}_{p} {I}_{s}$$

where P is the transferred power, M is the mutual inductance, Iₚ, Iₛ are the primary and secondary current, and ƒ is the operating frequency. For simplicity of analysis, the number of turns is assumed to be one for both the transmitter and receiver coil, Nₚ=Nₛ=1. Then, if the coupling coefficient gets smaller, either the frequency ƒ, or the currents Iₚ, Iₛ or both may be increased to maintain the power P constant. Increasing both the frequency and currents are limited by the capabilities of the semiconductor switches, coil, and magnetic material, e.g., size, cost, loss, and thermal limit.

Increasing the switching frequency, ƒ to compensate for the reduced coupling factor, k has multiple limitations. Higher frequency increases the switching loss in the semiconductor switches, e.g., reduces the effective cross-section of the coil-conductor due to the skin effect. On the other hand, increasing the coil currents, instead of the frequency, has a different set of limitations, such as the increased volume of copper and ferrite to support the additional current and flux while maintaining high efficiency. Also, the increased current causes additional conductive and switching loss in the semiconductor switches. The resonant component 100 according to one embodiment may mitigate against losses and inefficiencies in these high frequency applications.

In FIGS. 1-4, the resonant component 100 may include a first inductive portion 110 with a first end 114 and a second inductive portion 120 with a second end 124. Together, the first inductive portion 110 and the second inductive portion 120 may form at least a portion of the inductor 140. For instance, the first inductive portion 110 may correspond to a first half turn, and the second inductive portion 120 may correspond to a second half turn. The first and second half turns may define a first turn of the inductor 140 for transfer of wireless power.

The resonant component 100 may include first and second outputs 112, 122, which may respectively correspond to ends of the first and second inductive portions 110, 120 distal from the first and second ends 114, 124. For purposes of discussion, a resonant component (or other multi-resonant component configurations—e.g., a multi-turn configuration) is described herein as having outputs relative to the component, but in practice, the outputs may be configured to receive or provide power, functioning as an input or outlet and potentially as an input during one time period and an output during another time period. The resonant component, as described herein, may be utilized in one or both of a receiver and transmitter for wireless power.

The first end 114 may include a first electrode 134 operable to store electric charge. The first electrode 134 may be a separate component that is electrically connected to the first end 114, or the first electrode 134 may be integrated with the first end 114. The second end 124 may include a second electrode 132 operable to store electric charge. The second electrode 132 may be a separate component that is electrically connected to the second end 124, or the second electrode may be integrated with the second end 124. As an example, the first electrode 134 may correspond to a capacitor plate that is fastened at, or extends from, the first end 114 of the first portion 110, and the second electrode 132 may correspond to a capacitor plate that is fastened at, or extends from the second end 124 of the second portion 120.

The first and second electrodes 134, 132 in one embodiment may be defined by a portion of the inductor 140, such as at the ends of the inductor 140. The first and second electrodes 134, 132 may have a predetermined length measured from the respective ends of the inductor 140. For instance, the first and second electrodes 134, 132 may have a predetermined length from the respective ends of the copper foil winding of the inductor 140. The length may vary depending on the application, and target capacitance for that application.

The first and second electrodes 134, 132 may accumulate charge for the capacitor 130 (e.g., operable as charge plates), which is integral to the resonant component 100. In this way, the capacitance of the capacitor 130 is separate from any inherent self-capacitance of the inductive portions 110, 120 of the resonant component 100.

As shown in FIG. 2, the resonant component 100 may include a dielectric 136 sandwiched between the first electrode 134 and the second electrode 132 associated respectively with the first and second ends 114, 124. The first electrode 134, the second electrode 132, and the dielectric 136 form at least a portion of the capacitor 130 integral to the inductor 140 defined at least by the first and second inductive portions 110, 120.

The dielectric 136 may be sandwiched between the first and second ends 114, 124, such that the dielectric 136 is disposed in a layered arrangement that includes the first end 114, the first electrode 134, the dielectric 136, the second electrode 132, and the second end 124.

In the illustrated embodiment, a laminate, such as Rogers R30300, may be used as the dielectric 136. However, the material or materials of the dielectric 136 may vary from application to application. The dielectric 136 may be bonded to the first and second electrodes 134, 132 via an adhesive, e.g., an acrylic or epoxy adhesive—however, the present disclosure is not so limited. The dielectric 136 may be sandwiched between the first and second electrodes 134, 132 in any manner depending on the application.

Although one embodiment of the present disclosure is focused on the coil being made with the copper foil and the capacitor being printed on PCB board with low-loss dielectric material, the present disclosure is not so limited. An integrated capacitor and coil configuration may be constructed in a variety of ways, depending on the application. For instance, both the coil and capacitor may be provided on the same PCB board, making the resonant component highly compact.

The resonant component 100 in FIGS. 1-4 is configured in a series arrangement of the inductor 140 and the capacitor 130. It is to be understood that the present disclosure is not so limited, and that the inductor 140 and capacitor 130 may be arranged in a variety of configurations including but not limited to a series turning configuration, a parallel tuning configuration, or a series-parallel tuning configuration.

In one embodiment, the first and second inductive portions 110, 120 include first and second Cu-foil portions. For instance, the first and second inductive portions 110, 120 may be defined at least in part by Cu-foil. The first electrode 134 may be disposed directly on or integrated with the first end of a Cu-foil portion corresponding to the first inductive portion 110. The second electrode 132 may be disposed directly on or integrated with the second end of a Cu-foil portion corresponding to the second inductive portion 110.

Alternative materials and/or constructions, as mentioned herein, may be utilized for the inductive portions of the resonant component 100 (as well as other components described herein). For instance, in one embodiment, Litz wire and/or copper tube as an alternative to or in addition to the Cu foil may be utilized. Copper tube may have a relatively lower resistance relative to Litz wire. As the tube radius or the copper tube becomes larger, a larger amount of copper may be necessary to make the coil, while only a fraction of the copper tube surface may effectively conduct the current at 1-10 MHz. Alternatively, a copper foil, as described herein, may provide a similar resistance with a much smaller amount of copper and facilitate greater surface area for effectively conducting current at higher frequencies.

The resonant component 100 according to one embodiment includes a coil turn being split into two half turns or inductive portions 110, 120 and the capacitor 130 is connected to each half turn. This implements a series L-C system. The capacitor may be made from Rogers R30300, with a dielectric constant of 3. In order to ensure a higher breakdown voltage, the capacitor 130 may be implemented so that the full voltage is applied across double the dielectric thickness. In the illustrated embodiment, the capacitance is approximately 130 pF—although the present disclosure is not so limited, e.g., capacitance of the capacitor 130 may vary from application to application. The inductance of inductor 140 may be approximately 4.39 μH—although, like the capacitance, the present disclosure is not so limited, e.g., inductance of the inductor 140 may vary from application to application.

As described herein, additional turns may be provided for the resonant component 100. Each of these additional turns may or may not include an integrated capacitor similar to the construction of the integrated capacitor 130.

Although not depicted, a flux guide may be provided in conjunction with the resonant component 100, particularly for high frequency applications, such as above 1 MHz frequency. The flux guide in one configuration may include one or more ferrites (e.g., NiZn or MnZN ferrites or similar high-permeability materials). There are various classes of ferrites for different frequency ranges from 1 MHz to 10 MHz. As the frequency increases, the loss density in the ferrites may limit the maximum peak flux density on which the ferrites can be operated. A loss density of up to 400 kW/m³ may be thermally tolerated in the ferrite with natural convection. For that limit of loss density, 4F1 materials for the flux guide can be operated for up to 10 mT, which is much lower compared to its saturation flux density of approximately 250 mT. Therefore, the use of ferrite for such high frequency high power system may be considered for power and shielding targets for operation of the resonant component 100.

The diameter D of the resonant component 100 may vary from application to application. Additionally, as noted herein, the diameter D of the resonant component 100 in the form a transmitter may be the same or different from the diameter D of the resonant component 100 in the form of a receiver.

The thickness and/or dielectric parameter associated with the dielectric 136 may vary depending on the application. As an example, the thickness of the dielectric may be a few millimeters (e.g., 3 mm or less).

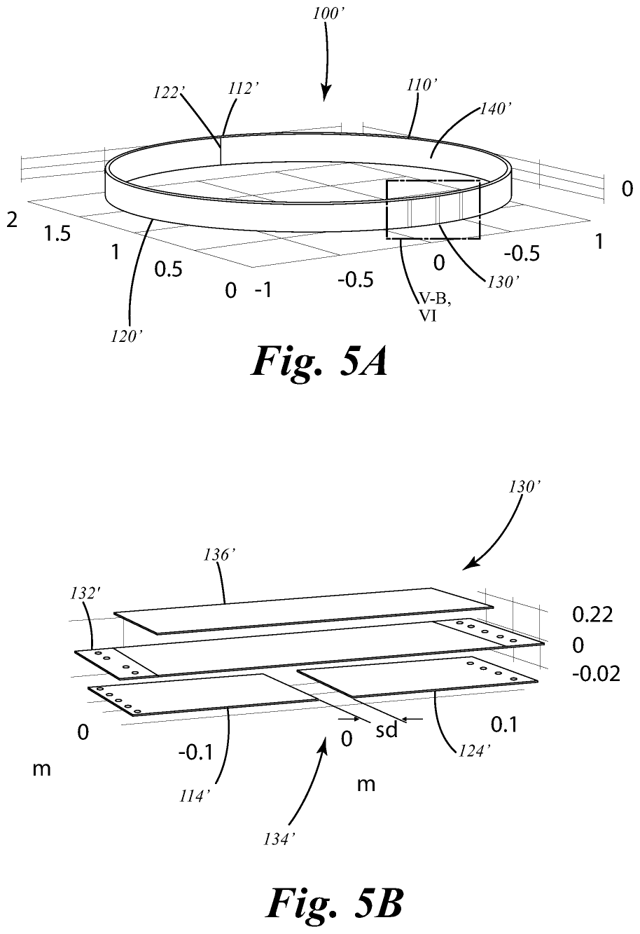

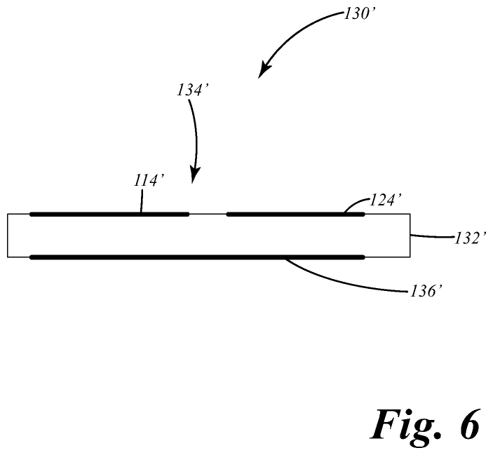

An alternative configuration of a resonant component is shown in FIGS. 5A, 5B, and 6 and is generally designated 100′. The resonant component 100′ is configured in a series tuning configuration. The resonant component 100′ is similar to the resonant component 100 in many respects, including an inductor 140 formed by first and second inductive portions 110′, 120′ similar to the first and second inductive portions 110, 120, including first and second ends 114′, 124′ and first and second outputs 112′, 122′ respectively distal from the first and second ends 114′, 124′. The material construction and alternative constructions and uses described in conjunction with like named components and aspects of the resonant component 100 may be adopted for the resonant component 100′.

The resonant component 100′ may include a capacitor 130′, which may be integral to the resonant component 100′. The first end 114′ of the first inductive portion 110′ of the resonant component 100′ and the second end 124′ of the second inductive portion 120′ of the resonant component 100′ may cooperatively provide a first electrode 134′ of the capacitor 130′. The first and second ends 114′, 124′ maybe separated by a distance SD. In one embodiment, this separation distance SD may electrically separate the first and second inductive portions 110′, 120′ such that there is no direct electrical path between the first and second ends 114′, 124′ thereof.

A floating electrode may be provided separate from the first and second inductive portions 110′, 120′ to define a second electrode 136′ of the capacitor 130′. The floating electrode may correspond to a floating plate, such as a plate formed of Cu foil.

The first electrode 134′ may be operable to store electric charge and may be separate or integral with the first end 114. The second electrode 136′ may be operable to store electric charge and is shown separate from both the first and second inductive portions 110′, 120′.

A dielectric 132′ may be provided similar to the dielectric 136 of the resonant component 100. The dielectric 132′ may be disposed between the first and second electrodes 134′, 136′, whereby the first and second electrodes 134′, 136′ and the dielectric 132′ may cooperatively form the capacitor 130′ in a manner that is integrated with the inductor 140′ and separate from any inherent self-capacitance of the inductor 140′.

The diameter D of the resonant component 100′ may vary from application to application. Additionally, as noted herein, the diameter D of the resonant component 100′ in the form a transmitter may be the same or different from the diameter D of the resonant component 100′ in the form a receiver.

The thickness and/or dielectric parameter associated with the dielectric 136′ may vary depending on the application. As an example, the thickness of the dielectric may be a few millimeters (e.g., 3 mm or less).

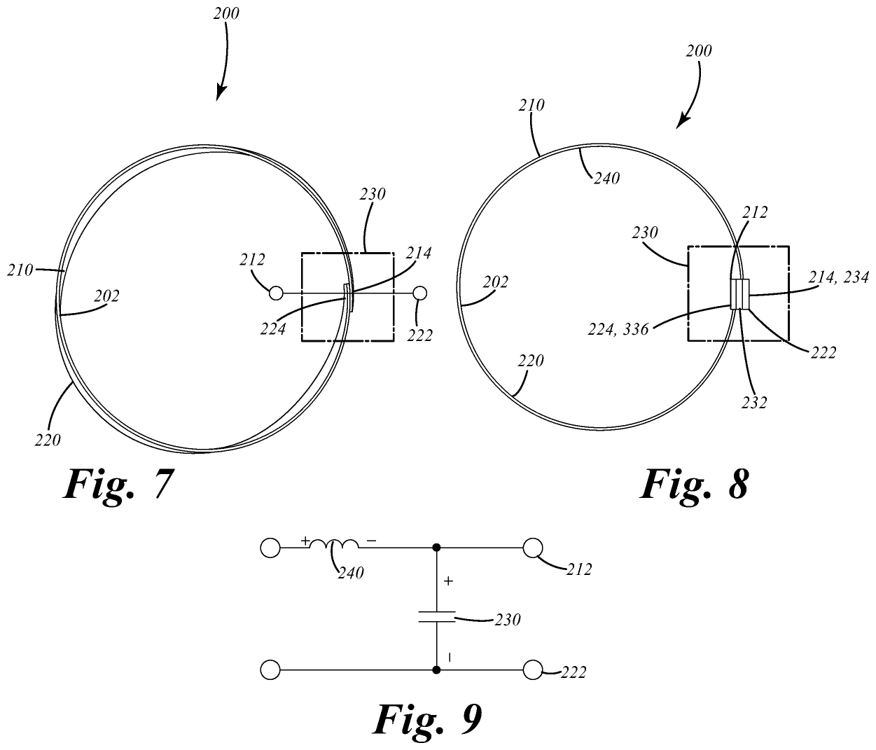

Turning to FIGS. 7-9, an alternative configuration of a resonant component is shown and generally designated 200. The resonant component 200 is configured in a parallel tuning configuration. The resonant component 200 is similar to the resonant component 100 in some respects, including an inductor 240 formed by first and second inductive portions 210, 220 and a capacitor 230 that is integral to the inductor 240. The first and second inductive portions 210, 220 may include first and second ends 214, 224. The first and second inductive portions 210, 220 may be electrically joined at a joint 202 at ends distal from the first and second ends 214, 224. Optionally, the joint 202 may be absent such that the first and second inductive portions 210, 220 are one-piece. Together, the first and second inductive portions 210, 220 form at least a portion of the inductor 240 of the resonant component 200. The material construction and alternative constructions and uses described in conjunction with like named components and aspects of the resonant component 100 may be adopted for the resonant component 200.

The resonant component 200 may include first and second outputs 212, 222, which may be electrically coupled to the first and second ends 214, 224 of the first and second inductive portions 110, 120. The connections of the first and second outputs 212, 222 in this configuration may provide a parallel tuning arrangement for the resonant component 200 as depicted in FIG. 9. This parallel tuning arrangement may be incorporated into a wireless power supply 1110 and/or a remote device 1102, as described herein.

Additionally, similar to the resonant component 100, the first end 214 may include a first electrode 234 operable to store electric charge. The first electrode 234 may be a separate component that is electrically connected to the first end 214, or the first electrode 234 may be integrated with the first end 214. The second end 224 may include a second electrode 232 operable to store electric charge. The second electrode 232 may be a separate component that is electrically connected to the second end 224, or the second electrode may be integrated with the second end 224.

The first and second electrodes 234, 232 may accumulate charge for the capacitor 230 (e.g., operable as charge plates), which is integral to the resonant component 100. In this way, the capacitance of the capacitor 230 is separate from any inherent self-capacitance of the inductive portions 210, 220 of the resonant component 200.

The resonant component 200 may include a dielectric 236 sandwiched between the first electrode 234 and the second electrode 232 associated respectively with the first and second ends 214, 224. The first electrode 234, the second electrode 232, and the dielectric 236 form at least a portion of capacitor 230 integral to the inductor 240 defined at least by the first and second inductive portions 210, 220.

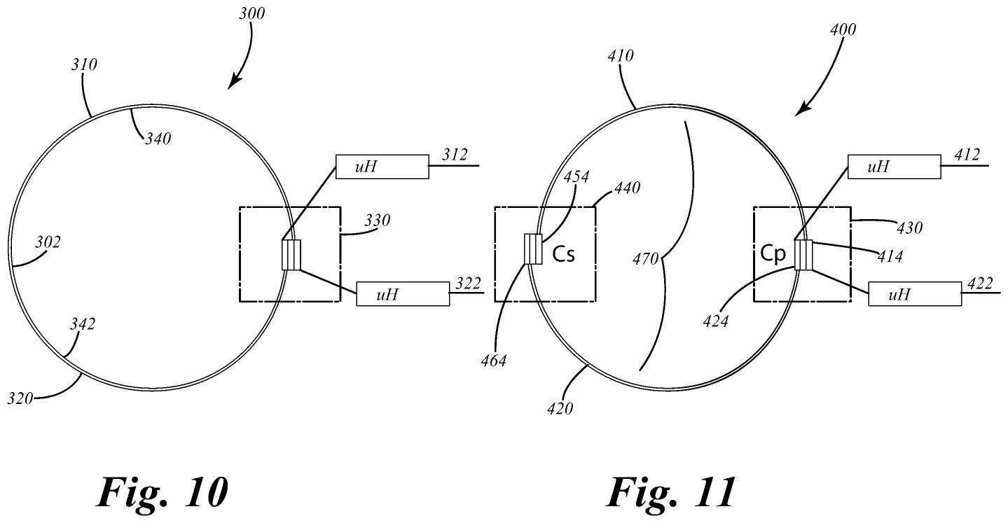

Alternative tuning configurations are depicted in the illustrated embodiments of FIGS. 10 and 11, including a resonant component 300 configured for an LCL tuning configuration and a resonant component 400 configured for an LCC tuning configuration. The material construction and alternative constructions and uses described in conjunction with like named components and aspects of the resonant component 100 may be adopted for the resonant component 300.

The resonant component 300 may include a first inductive portion 310 with a first end and a second inductive portion 320 with a second end. The first inductive portion 310 and the second inductive portion 320 may respectively provide at least portions of first and second inductor 340, 342. The first inductor 340 and the second inductor 342 may have an inductance of 1.1 μH—although the inductance may vary from application to application.

The resonant component 300 may include first and second outputs 312, 322, which may respectively correspond to ends of the first and second inductive portions 310, 320. The first and second portions 310, 320 may be electrically joined at a joint 302 at ends distal from the first and second ends of the first and second inductive portions 310, 320. Optionally, the joint 302 may be absent such that the first and second inductive portions 310, 320 are one-piece.

The connections of the first and second outputs 312, 322 in conjunction with the capacitor 330 may provide an LCL (inductor 340-capacitor 330-inductor 342) tuning arrangement for the resonant component 300.

The capacitor 330 may be integral to the inductor arrangement of the resonant component 300 in a manner similar to the capacitor 130 or the capacitor 230 so that the capacitor 330 provides capacitance separate from the self-capacitance of the first and second inductors 340, 342.

The LCL tuning arrangement of the resonant component 300 may be incorporated into a wireless power supply 1110 and/or a remote device 1102, as described herein.

The resonant component 400 may include a first inductive portion 410 with a first end 414 and a second inductive portion 420 with a second end 424, similar to the first and second ends 114, 124 of the resonant component 100. Together, the first inductive portion 410 and the second inductive portion 420 may form at least a portion of an inductor 470. For instance, the first inductive portion 410 may correspond to a first half turn, and the second inductive portion 420 may correspond to a second half turn. The first and second half turns may define a first turn of the inductor 470 for transfer of wireless power. The material construction and alternative constructions and uses described in conjunction with like named components and aspects of the resonant component 100 may be adopted for the resonant component 400.

The first end 414 may include a first electrode operable to store electric charge. The first electrode may be a separate component that is electrically connected to the first end 414, or the first electrode may be integrated with the first end 414.

The second end 424 may include a second electrode operable to store electric charge. The second electrode may be a separate component that is electrically connected to the second end 124, or the second electrode may be integrated with the second end 424.

The first and second electrodes associated with the first and second ends 414, 424 may accumulate charge and may be separated by a dielectric to form a capacitor 430, which is integral to the resonant component 400. In this way, the capacitance of the capacitor 430 is separate from any inherent self-capacitance of the inductive portions 410, 420 of the resonant component 400.

The first inductive portion 410 may include a third end 454 distal from the first end 414, and the second inductive portion 420 may include a fourth and 464 distal from the second end 424. The third end 454 may include a third electrode operable to store electric charge, the fourth end 464 may include a fourth electrode operable to store electric charge. The third and fourth electrodes may be separate components that are electrically connected respectively to the third end 454 and the fourth end 464, or the third and fourth electrodes may be integrated respectively with the third end 454 and the fourth end 464.

The third and fourth electrodes associated with the third and fourth ends 454, 464 may accumulate charge and may be separated by a dielectric to form a capacitor 440, which is integral to the resonant component 400. In this way, the capacitance of the capacitor 440 is separate from any inherent self-capacitance of the inductive portions 410, 420 of the resonant component 400.

The resonant component 400 may include first and second outputs 412, 422, which may respectively correspond to first and second ends 414, 424 of the first and second inductive portions 410, 420. The connections of the first and second outputs 412, 422 in conjunction with the capacitor 430 and the capacitor 440 may provide an LCC (inductor 470-capacitor 430-capacitor 440) tuning arrangement for the resonant component 400. The first inductive portion 410 and the second inductive portion 420 may have an inductance of 1.1 μH—although the inductance may vary from application to application.

The LCC tuning arrangement of the resonant component 400 may be incorporated into a wireless power supply 1110 and/or a remote device 1102, as described herein. For instance, first and second capacitors of a first resonant component 400 may be provided in a wireless power supply 1110, and third and fourth capacitors of a second resonant component 400 may be provided in a remote device 1102.

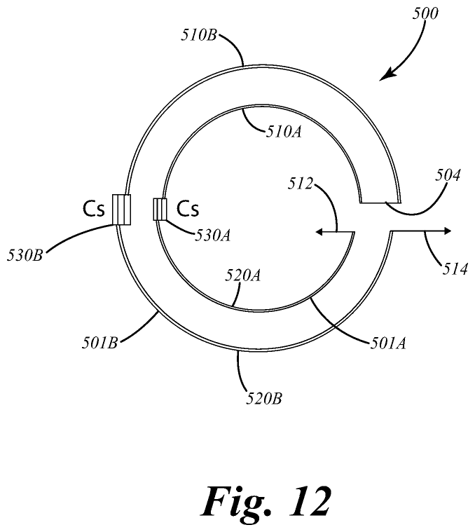

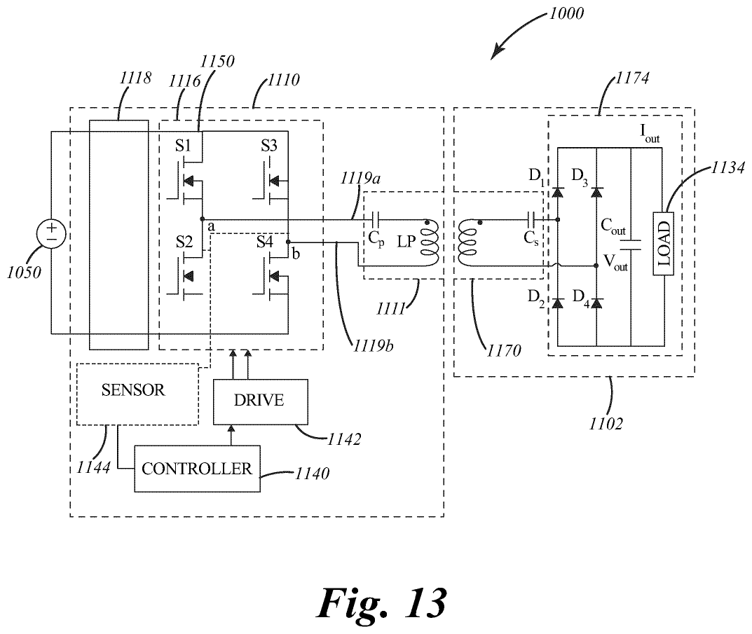

In the illustrated embodiment of FIG. 12, a multi-turn configuration is shown and generally designated 500. The material construction and alternative constructions and uses described in conjunction with like named components and aspects of the resonant component 100 may be adopted for the resonant component 500.

The multi-turn configuration 500 may form a resonant component that includes a plurality of resonant components according to one or more embodiments described herein. For instance, the multi-turn configuration 500 may include a first resonant component 501-A and a second resonant component 501-B. The first resonant component 501-A may be configured similar to the resonant component 100, and the second resonant component 501-B may be configured similar to the resonant component 100 as well. The first and second resonant components 501-A, 501-B may be electrically connected at respective ends via a coupler 504, while ends distal from the coupler 504 may provide respective first and second outputs 512, 514, to which a component of a remote device or WPS may be coupled for receipt or supply of wireless power.

Additional turns of the multi-turn configuration 500 may be configured in a similar manner, with each additional resonant component being electrically connected at one end via a coupler to another resonant component and coupled to either an output or another resonant component via a coupler.

The first and second resonant components 501-A, 501-B may respectively include capacitors 530-A, 530-B, which may be coupled respectively to first and second inductive portions 510-A, 510-B, 520-A, 520-B, which may be similar to the first and second inductive portions 110, 120. Likewise, the capacitors 530-A, 530-B may be configured similar to the capacitor 130 of the resonant component 100. For instance, the capacitors 530-A, 530-B may be formed by first and second electrodes associated with first and second ends of the first and second inductive portions 510-A, 510-B, 520-A, 520-B, with a dielectric material provided between the first and second electrodes for each of the capacitors 530-A, 530-B. In this way, capacitances for the type of tuning can be integrated with each or more than one turn of the multi-turn configuration 500.

The resonant components 501-A, 501-B may correspond to one-to-one copies of each other, with the exception of potential differences in diameter size and/or position.

In the illustrated embodiment of FIG. 13, a wireless power system in accordance with one embodiment is shown and generally designated 1000. The wireless power system 1000 may include a resonant component according to one or more embodiments described herein. It is noted, however, that the resonant component is not limited to wireless power systems and may be provided in any type of application.

The wireless power system 1000 according to one embodiment may include a transmitter 1111 and a receiver 1170 and may each include a resonant component 100. The wireless power system 1000 may be configured to transfer one kilowatt of power at a distance of approximately 3 meters. The transmitter and receiver may have a measured resonance frequency of 6.45 and 6.6 MHz—although the present disclosure is not so limited. The resonant frequency of the transmitter and receiver may vary from application to application, such as in the frequency range of approximately 85 kHz (e.g., for EV charging applications). The inverter and rectifiers may be positioned proximal or close to the coil to reduce or minimize the variation of the coil inductance and capacitance due to the additional lead-wire. The wireless power system 1000 may include a GaN-based inverter and a GaN-based rectifier assembly, one or both with a liquid cooled copper heat-sink.

The wireless power system 1000 in the illustrated embodiment includes a remote device 1102 and a wireless power supply 1110 configured to transmit wireless power to the remote device 1102. The remote device 1102 may be described as a secondary-side, vehicle-side, or receiver-side with respect to the wireless power supply 1110. The wireless power supply 1110 may be provided as part of an off-board transmitter, which is separate from the remote device 1102. The off-board transmitter and/or the other aspects of the wireless power supply 1110 may be disposed on the ground, a wall, or a ceiling. Circuitry of the remote device 1102 that is configured for receiving power from the wireless power supply 1110 may be provided as part of an on-board receiver.

In one embodiment, the remote device 1102 may be operable to transmit power to the wireless power supply 1110 (if the diodes in 1102 are replaced with active switches [e.g., an inverter circuit according to one embodiment described herein]), which may be configured to receive wireless power in addition to or as an alternative to transmitting wireless power to the remote device 1102. The remote device 1102 or one or more components thereof may be incorporated into any type of apparatus or device, including, for instance, an air mobility vehicle (e.g., a drone or a UAV), a ground-based vehicle, a mobile phone, a table top appliance, a laptop, a tablet, or a power tool charger or any type of isolated power supply configuration for wireless power with resident converters, and may be configured in accordance with one or more embodiments described herein.

Additional examples of applications include a vehicle provided as an electric vehicle, a plug-in hybrid electric vehicle, or an electric/plug-in hybrid combat vehicle. Further example applications can relate to energy storage provided in a variety of forms, including a stationary or mobile energy storage system, a low/high voltage battery charger being a cell phone, a laptop, a tablet, a power tool, a gardening tool, a handheld vacuum cleaner, a kitchen gadget, any type of battery charger or adapter, chargers for portable electronics (including cameras, laptops, and cell phones), house-hold appliances with grid isolation requirements, air mobility vehicles (such as electric/hybrid propulsion aircraft, drones, UAVs, and satellites), laser or plasma applications, LEDs, single-phase or three-phase grid systems with medium or low grid voltage networks, fuel cell, solar, or wind turbine renewable energy conversion systems, microturbines (e.g., in grid connected applications), and High Voltage (HV) systems.

The remote device 1102 in the illustrated embodiment includes a load 1134, such as a battery, operable to use power received wirelessly from the wireless power supply 1110. For instance, the wireless power receiver 1170 may be coupled to a load 1134 to provide power thereto. The load 1134 in the illustrated embodiment is part of or coupled to receiver-side circuitry 1174 (or secondary-side circuitry) operable to receive power from the wireless power receiver 1170. The load 1134 may include a battery (or a battery and a battery management system [BMS]) or any type of principle load, or a combination thereof.

The wireless power receiver 1170 in the illustrated embodiment may include a resonant component according to one more configurations described herein, including, for instance, the resonant component 100, 100′, 200, 300, 400, 500.

In the illustrated embodiment of FIG. 13, the wireless power supply 1110 may include a wireless power transmitter 1111, which may include a resonant component according to one or more configurations described herein, including, for instance, the resonant component 100, 100′, 200, 300, 400, 500.

The wireless power supply 1110 may be operable to receive power from a source 1050, which may be a DC source. Alternatively, the source 1050 may be an AC source, and the wireless power supply 1110 may receive power from an AC grid connection. In this configuration, a grid interface converter, such as an AC/DC rectifier may be used to supply power to switching circuitry 1116 (e.g., an inverter) as described herein. In one embodiment, the AC source before such an AC/DC rectifier may be provided via grid power or utility power, and may be single phase or three-phase depending on the application as described herein.

The wireless power supply 1110 in the illustrated embodiment includes a controller 1140 operably coupled to drive circuitry 1142. The drive circuitry 1142 may include a multiplexor or signal conditioning circuitry, or both, in the form of a gate driver interface to translate output from the controller 1140 to direct operation of the switching circuitry 1116. Alternatively, the drive circuitry 1142 may correspond to pass through conductors that provide a direct connection between switching circuitry 1116 and the controller 1140.

The wireless power supply 1110 may optionally include a sensor 1144 (optional). The sensor 1144 may be configured to detect a characteristic of power of the wireless power supply 1110, such as a characteristic of power in the switching circuitry 1116. The characteristic of power may pertain to a voltage or current measured or determined with respect to output nodes a, b. The output from the sensor 1144 may be digital or analog and indicative of the detected characteristic of power. This output from the sensor 1144 may be provided to the controller 1140. The sensor 1144 is shown separate from the controller 1140, but may be integral therewith in one embodiment. The sensor 1144 is not limited to the configuration described and shown in conjunction with FIG. 13—for instance, the sensor 1144 may sense a characteristic of power in a portion of the wireless power supply 1110.

The switching circuitry 1116 in the illustrated embodiment includes a full-bridge inverter configuration with first, second, third, and fourth switches S1, S2, S3, S4 capable of operating in conjunction with each other to supply power to the transmitter 1111. The switching circuitry 1116 may also be configured in a half-bridge configuration with fewer switches (i.e., switches S1, S2). Additionally, or alternatively, the switching circuitry 1116 may be configured as a three-phase inverter with additional sets of switches.

The switches S1, S2, S3, S4 in the illustrated embodiment are configured MOSFETs each with a source, a drain, and a gate. The gates of the switches S1, S2, S3, S4 may be coupled to the drive circuitry 1142 and operable in response to one or more signals from the drive circuitry 1142. Control over the gate of the switches S1, S2, S3, S4 may enable and disable current flow between the upper and lower nodes (e.g., between the drain and source) of the respective switches S1, S2, S3, S4 thereby controlling voltage and current with respect to output nodes 1119a-b (nodes a and b) between the lower node of switch S1 and the upper node of switch S2 and between the lower node of switch S3 and the upper node of switch S4.

The switching circuitry 1116 may be configured to receive input power 1150 from the power supply 1050, and to generate AC power to be supplied to the transmitter 1111. The controller 1140 may direct operation of the switching circuitry 1116 according to a switching frequency and duty cycle (pulse width) to generate the high-frequency AC power. The switching frequency may be between 3 kHz and 10 MHz, and may optionally be about 85 kHz. In one embodiment, the controller 1140 may be operable to vary a switching frequency of the switching circuitry 1116. As an example, the controller 1140 may obtain sensor feedback from the sensor 1144, and adjust the switching frequency or the duty cycle (e.g., pulse width) based on the sensor feedback.

The switches S1, S2, S3, S4 may be MOSFETs or any other type of switch capable of selectively supplying power to the transmitter 1111, including for example IGBTs.

In the illustrated embodiment, the wireless power supply 1110 includes power conditioning circuitry 1118 capable of conditioning the power received from the power source 1050. The power conditioning circuitry 1118 in the illustrated embodiment corresponds to a pass-through configuration between the power supply 1050 and the switching circuitry 1116. However, the present disclosure is not so limited. As an example, the power conditioning circuitry 1118 may correspond to rectification circuitry operable to rectify AC power received from an AC power source into DC power as the input power 1150 provided to the switching circuitry 1116. Additionally, or alternatively, the power conditioning circuitry may include filter or compensation circuitry, such as a choke inductor, a parallel capacitor (e.g., a bulk capacitor), or a combination of an inductor and capacitor to form a filter at the point of grid connection. If the power conditioning circuitry 1118 is utilized for a grid interface, then the source 1050 may be a single or three-phase AC source. If a grid interface is not used or bypassed, then the source 1050 is a DC source.

The controller 1140 may be coupled to one or more components of the wireless power systems to achieve operation in accordance with the described functionality and methodology.

The controller 1140 may include electrical circuitry and components to carry out the functions and algorithms described herein. Generally speaking, the controller 1140 may include one or more microcontrollers, microprocessors, digital signal processors (DSP), and/or other programmable electronics that are programmed to carry out the functions described herein. The controller 1140 may additionally or alternatively include other electronic components that are programmed to carry out the functions described herein, or that support the microcontrollers, microprocessors, and/or other electronics. The other electronic components include, but are not limited to, one or more field programmable gate arrays (FPGAs), systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the system or aspects thereof, or they may reside in a common location within the system or an aspect thereof. When physically distributed, the components may communicate using any suitable serial or parallel communication protocol, such as, but not limited to, CAN, LIN, Vehicle Area Network (VAN), Fire Wire, I2C, RS-232, RS-485, Ethernet, LAN, WiFi, and Universal Serial Bus (USB).

The wireless power system 1000, in the illustrated embodiment, is configured to receive power from the source 1050 in the form of an AC power source, and includes power conditioning circuitry 1118 configured to rectify the AC power received from the source 1050 into DC power for the switching circuitry 1116. By selective control of the switching circuitry 1116, power may be supplied to the transmitter 1111 in order to transfer power wirelessly to the receiver 1170.

Power transmitted wirelessly from the transmitter 1111 to the receiver 1170 may be provided to receiver-side circuitry 1174, which may rectify AC power output from the receiver 1170 into DC power supplied to the load 1134 (e.g., a battery).

For a wireless power system 1000 in accordance with one embodiment, the primary transmitter, also described as a transmitter 1111 or transmitter inductance, may incorporate a resonant component according to one embodiment described herein, including an integrated capacitance and inductance, and may vary from application to application depending on construction, a primary-side current, or a power level, or a combination thereof. Likewise, the secondary receiver, also described as a receiver 1170 or receiver inductance, may incorporate a resonant component according to one embodiment described herein, including an integrated capacitance and inductance, and may vary from application to application depending on construction, a secondary-side current, or a power level, or a combination thereof.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A wireless charging system (WCS) for wirelessly providing high-frequency AC power to an electric vehicle (EV), the WCS comprising:
an off-board transmitter (TX) including:
a primary coil configured to wirelessly transmit the high-frequency AC power, the primary coil including Cu-foil winding, and
a primary-side resonant-tuning network (RTN) that is integrally formed with the primary coil, the primary-side RTN including a first capacitor that includes first Cu plates located at the ends of the primary coil's Cu-foil winding, and a dielectric sandwiched between the first Cu plates; and
an on-board receiver (RX) including:
a secondary coil configured to receive the high-frequency AC power when the secondary coil and the primary coil are disposed adjacent to each other and spaced apart through a gap d, the secondary coil including Cu foil winding, and
a secondary-side RTN that is integrally formed with the secondary coil, the secondary-side RTN including a second capacitor that includes second Cu plates located at the ends of the secondary coil's Cu-foil winding, and another dielectric sandwiched between the second Cu plates.

2. The WCS of claim 1, wherein:
the first capacitor's first plates are portions of the primary coil's Cu-foil winding, the portions having a predetermined length measured from respective ends of the primary coil's Cu-foil winding, and
the second capacitor's second plates are portions of the secondary coil's Cu-foil winding, the portions having the predetermined length measured from respective ends of the secondary coil's Cu-foil winding.

3. The WCS of claim 1, wherein:
the first capacitor's first plates are fastened at, and extend from, respective ends of the primary coil's Cu-foil winding; and
the second capacitor's second plates are fastened at, and extend from, respective ends of the secondary coil's Cu-foil winding.

4. The WCS of claim 1, wherein:
the primary coil includes multiple Cu-foil windings;
the secondary coil includes multiple Cu-foil windings; and
the secondary-side RTN includes copies of the second capacitor in one-to-one correspondence with the secondary coil's Cu-foil windings.

5. The WCS of claim 4, wherein:
the primary-side RTN includes at least one copy of the first capacitor; and
the secondary-side RTN includes at least one copy of the second capacitor.

6. The WCS of claim 5, wherein:
the primary-side RTN includes copies of the first capacitor in one-to-one correspondence with the primary coil's Cu-foil windings;
the secondary-side RTN includes copies of the second capacitor in one-to-one correspondence with the secondary coil's Cu-foil windings.

7. The WCS of claim 1, wherein:
the off-board TX includes an inverter;
the primary coil's Cu-foil winding includes first electrical terminals for connecting the primary-side RTN to the inverter, the first electrical terminals disposed distal from its ends where the first capacitor is disposed;
the on-board RX includes a rectifier; and
the secondary coil's Cu-foil winding includes second electrical terminals for connecting the secondary-side RTN to the rectifier, the second electrical terminals disposed distal from its ends where the second capacitor is disposed.

8. The WCS of claim 1, wherein:
the off-board TX includes an inverter;
the primary coil's Cu-foil winding includes first electrical terminals for coupling the primary-side RTN to the inverter, the first electrical terminals disposed across its ends where the first capacitor is disposed;
the on-board RX includes a rectifier; and
the secondary coil's Cu-foil winding includes second electrical terminals for coupling the secondary-side RTN to the rectifier, the second electrical terminals disposed across its ends where the second capacitor is disposed.

9. The WCS of claim 8, wherein:
the primary-side RTN includes two first inductors connected between the respective first electrical terminals and the inverter, and
the secondary-side RTN includes two second inductors connected between the respective second electrical terminals and the rectifier.

10. The WCS of claim 9, wherein:
the primary-side RTN further includes a third capacitor that includes third Cu plates located distal from the ends of the primary coil's Cu-foil winding where the first capacitor is disposed, and the dielectric sandwiched between the third Cu plates, and
the secondary-side RTN further includes a fourth capacitor that includes fourth Cu plates located distal from the ends of the secondary coil's Cu-foil winding where the second capacitor is disposed, and the dielectric sandwiched between the fourth Cu plates.

11. The WCS of claim 1, wherein the high-frequency AC power is in a range of 1-10 kW.

12. The WCS of claim 1, wherein a fundamental frequency of the high-frequency AC power is in a range of 1 MHz-10 MHz.

13. The WCS of claim 1, wherein a ratio of the gap d to a diameter D of the Cu-foil winding(s) satisfies the conditions 1<d/D<2.

14. The WCS of claim 1, wherein the gap d is in a range of 1 m to 10 m.

15. The WCS of claim 1, wherein the EV is one of an automobile, a watercraft, or an aircraft.

16. The WCS of claim 1, wherein the EV is an autonomous vehicle.

17. The WCS of claim 1, wherein the off-board TX is disposed on the ground, a wall, or a ceiling.

18. The WCS of claim 1, wherein the off-board TX is disposed on an automobile, a watercraft, or an aircraft.

19. A resonant component for transfer of wireless power between a wireless power supply and a remote device, the resonant component comprising:
a first inductive portion including a first end and a second inductive portion including a second end;
a first electrode operable to store electric charge, the first electrode provided at the first end of the first inductive portion;
a second electrode operable to store electric charge, the second electrode provided at the second end of the second inductive portion; and
a dielectric sandwiched between the first electrode and the second electrode, wherein the first electrode, the second electrode, and the dielectric form a capacitor integral to an inductor defined at least by the first and second inductive portions.

20. The resonant component of claim 19, wherein the resonant component corresponds to at least one of a wireless transmitter and a wireless receiver respectively for the wireless power supply and the remote device.

21. The resonant component of claim 19, wherein the first and second inductive portions include first and second Cu-foil portions, and wherein the first electrode is disposed directly on the first end of the first Cu-foil portion.

22. The resonant component of claim 21, wherein the second electrode is disposed directly on the second end of the second Cu-foil portion.

23. The resonant component of claim 22, wherein the dielectric is sandwiched between the first and second ends of the first and second Cu-foil portions, such that the dielectric is disposed in a layered arrangement that includes the first end, the first electrode, the dielectric, the second electrode, and the second end.

24. The resonant component of claim 19, wherein the first electrode is fastened at, and extends from, the first end of the first inductive portion.

25. The resonant component of claim 19, wherein the second electrode is fastened at, and extends from, the second end of the second inductive portion.

26. The resonant component of claim 19, wherein the first electrode corresponds to a first capacitor plate of the capacitor, and wherein the second electrode corresponds to a second capacitor plate of the capacitor.

27. The resonant component of claim 19, wherein the first inductive portion corresponds to a first half turn, wherein the second inductive portion corresponds to a second half turn, and wherein the first and second half turns define a first turn of the inductor for transfer of wireless power.

28. The resonant component of claim 27, wherein the capacitor and the inductor are operable to resonate.

29. The resonant component of claim 19, wherein the inductor includes at least one additional turn, wherein each of the at least one additional turns includes:
a first additional inductive portion including a first additional end and a second additional inductive portion including a second additional end;
a first additional electrode operable to store electric charge, the first additional electrode being electrically coupled to the first additional end of the first additional inductive portion;
a second additional electrode operable to store electric charge, the second additional electrode being electrically coupled to the second additional end of the second additional inductive portion; and
an additional dielectric sandwiched between the first and second additional electrodes, wherein the first additional electrode, the second additional electrode, and the additional dielectric form an additional capacitor integral to an additional inductor defined by the first and second additional inductive portions.

30. A wireless power supply for supply of power wirelessly a remote device, the wireless power supply comprising:
a wireless power transmitter according to the resonant component of claim 19;
a power source interface operable to receive power from a power source; and
a converter electrically coupled to an output of the power source interface, the converter configured to convert power from the output of the power source interface for supply to the wireless power transmitter to transmit power wirelessly to the remote device.

31. A remote device for receipt of power wirelessly transmitted by a wireless power supply, the remote device comprising:
a wireless power receiver according to the resonant component of claim 19;
a rectifier operably coupled to the wireless power receiver, the rectifier operable to convert AC power output from the wireless power receiver into DC power as an output; and
a load operably coupled to the output of the rectifier, the load operable to draw DC power from the rectifier.

32. The resonant component of claim 19, wherein the inductor and capacitor are arranged in a series turning configuration, a parallel tuning configuration, or a series-parallel tuning configuration.
